(19) United States
(12) Patent Application Publication
(10) Pub. No.: US 2007/0051601 A1
(43) Pub. Date: Mar. 8, 2007

(54) Closeable electronics device

(76) Inventors: Hu-Sen Wang, Hexi District (CN); Qing-Bo Chen, Hexi District (CN)

Correspondence Address: MOTOROLA INC, 600 NORTH US HIGHWAY 45, ROOM AS437, LIBERTYVILLE, IL, 60048-5343, US

(21) Appl. No.: 10/558,952

(22) PCT Filed: Oct. 4, 2005
(86) PCT No.: PCT/US05/35668

§ 371 Date: Nov. 30, 2005

(30) Foreign Application Priority Data
Oct. 20, 2004 (CN) 200410086922.5

(51) Int. Cl. H01H 1/00

(52) U.S. Cl. 200/284

(57) ABSTRACT

A closeable electronics device (100) that includes housing having at least two portions pivotally mounted to each other about a pivotal axis (A) allowing relative movement of the portions between an opened position and closed position. The portions are a first portion (205) having a detector aperture (215) and a second portion (210) having a protruding detector actuator (220) positioned for operative engagement with the aperture (215) when the portions are in the closed position. The device (100) also has a circuit board (530) disposed in the first portion (205) and two spaced switch contacts (540, 550) are disposed on the circuit board (530). There is also a resilient pad (405) supported by the circuit board (530), the resilient pad (405) having an actuator engaging surface (410) disposed in the aperture (215). A conductive shorting member (515) disposed on the resilient pad (405) with a switch contacting surface (610) of shorting member (515) aligned with and facing the switch contacts (540, 550). The conductive shorting member (515) is biased away from the switch contacts (540, 550) by resilient properties of the pad (405). A plane (PA) of the actuator engaging surface (410) is at an angle φ to a plane (PS) of the switch contacting surface (610), and wherein the plane (PA) of the actuator engaging surface (410) is both parallel to and facing the pivotal axis (A).

### FIELD OF THE INVENTION

This invention relates to a closeable electronics device, the electronics device has a two part housing movable about a pivotal axis from a closed to an opened position and vice versa.

### BACKGROUND OF THE INVENTION

Electronics devices and more specifically electronics communication devices, such as radio or cellular telephones, that are easy to transport and support desirable features are becoming commonplace. One communication device that is easy to transport is a closeable cellular telephone having a two part housing movable from an opened position to a closed position and vice versa. In the opened position, a conventional cellular telephone user interface includes a speaker, a microphone, a display and a keypad that are fully exposed and accessible by a user. Also, in the opened position, the cellular telephone has a length that is sufficient to allow the ear and mouth of the user to align with the speaker and microphone, respectively.

In the closed position the cellular telephone is shorter in length and typically when the cellular telephone is moved from the closed to the opened position a detector such as an electro-mechanical switch, cam actuated switch, a protruding detector actuator and associated biased switch assembly or any other suitable switching mechanism detects this movement and actuates one or more telephone functions. Such telephone functions include auto call answer, auto muting of the audible alert and auto illumination and driving of a display of the telephone. Similarly, when the telephone is moved from the opened position to the closed position the detector detects this movement and actuates telephone functions such as end a telephone call and auto de-activation of illumination and driving of the display.

When using a protruding detector actuator and associated biased switch assembly as the detector, there is typically an advantage of cost and possibly space saving as compared to the other abovementioned detectors. However, the reliability of this type of detector may sometimes be compromised. For instance, the protruding detector actuator and associated biased switch assembly includes a resilient pad that engages with the protruding detector actuator. This engagement moves (in a switch actuating direction) a shorting member of a resilient pad against switch contacts. However, the protruding detector actuator and resilient pad are located on different parts of the two part housing and therefore the pivotal movement that allows engagement of engaging surfaces of the pad and protruding detector actuator inherently exerts an undesirable force lateral to the switch actuating direction. This undesirable force causes unwanted distortion of the pad that may result in reliability issues and incorrect functioning of the detector.

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed. Also, the terms inactivating and inoperable have the same meaning and can be used interchangeably throughout this specification. Similarly, the terms activating and operable have the same meaning and can be used interchangeably throughout this specification

### SUMMARY OF THE INVENTION

According to one aspect of the invention there is provided a closeable electronics device comprising:
a housing having at least two portions pivotally mounted to each other about a pivotal axis allowing relative movement thereof between an opened position and closed position, the portions being a first portion having an detector aperture therein and a second portion having a protruding detector actuator positioned for operative engagement with the aperture when the portions are in the closed position;
a circuit board disposed in the first portion;
two spaced switch contacts disposed on the circuit board,
a resilient pad supported by the circuit board and having an actuator engaging surface disposed in the aperture; and
a conductive shorting member disposed on the pad and having a switch contacting surface aligned with and facing the switch contacts, the conductive shorting member being biased away from the switch contacts by resilient properties of the pad, wherein a plane of the actuator engaging surface is at an angle to a plane of the switch contacting surface, and wherein the plane of the actuator engaging surface is both parallel to and facing the pivotal axis.

Suitably, when in the closed position a pad engaging surface of the protruding detector actuator operatively engages the actuator engaging surface of the pad, wherein the pad engaging surface has a plane substantially parallel to the plane of the switch contacting surface.

Suitably, when the portions move between an opened position to the closed position the protruding detector actuator operatively engages the pad to provide a force overcoming biasing of the resilient properties and moving the conductive shorting member against the switch contacts, wherein the angle of plane of the actuator engaging surface relative to the plane of the switch contacting surface is such that the force has a direction substantially normal to the plane of the switch contacting surface.

It could be useful if the angle of plane of the actuator engaging surface relative to the plane of the switch contacting surface is between 10 to 20 degrees.

The two portions may be pivotally mounted to each other about the pivotal axis by a hinge.

Suitably, the detector aperture is proximal to the hinge. In one suitable form, the detector aperture is located less than 1 Centimetre from the pivotal axis A of the hinge. Also, the protruding detector actuator is proximal to the hinge and may be suitably located less than 1 Centimetre from pivotal axis A of the hinge.

The pad may be formed from a moulded resilient rubber based material. Suitably, the pad may be integrally moulded into a keypad of the device.

Suitably, one of the switch contacts is operatively coupled to a processor of the device.

### BRIEF DESCRIPTION OF THE DRAWINGS

In order that the invention may be readily understood and put into practical effect, reference will now be made to exemplary embodiments as illustrated with reference to the accompanying drawings in which:

FIG. 1 is a block diagram illustrating circuitry of a closeable electronics device in accordance with an embodiment of the invention;

FIG. 2 illustrates an embodiment of the closeable radio communications device of FIG. 1 when in a fully opened position;

FIG. 3 illustrates an embodiment of the closeable radio communications device of FIG. 1 when in a fully closed position;

FIG. 4 illustrates a hinge and surrounding area of the closeable radio communications device of FIG. 1 when in a fully opened position;

FIG. 5 illustrates an exploded perspective view of a first portion the closeable radio communications device of FIG. 1; and

FIG. 6 is a schematic cross sectional view of part of the closeable radio communications device of FIG. 1 when in a partially opened position; and

FIG. 7 is a schematic cross sectional view of part of the closeable radio communications device of FIG. 1 when in a fully closed position.

### DETAILED DESCRIPTION OF THE PREFERRED EMBODIMENT OF THE INVENTION

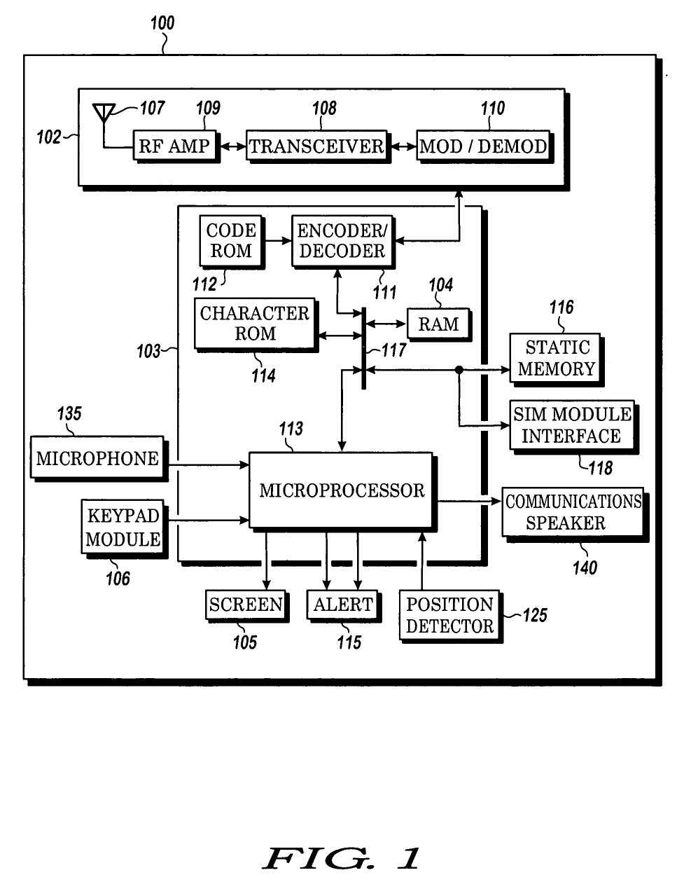

In the drawings, like numerals on different Figs are used to indicate like elements throughout. With reference to FIG. 1, there is illustrated a closeable electronics device in the form a radio telephone 100 comprising a radio frequency communications unit 102 coupled to be in communication with a processor 103. The radio telephone 100 also has a keypad module 106 and a display screen 105 operatively coupled to be in communication with the processor 103. As will be apparent to a person skilled in the art, display screen 105 may be a touch screen thereby making the keypad module 106 optional or at least reducing the number of keys/buttons thereon. There is also a housing position detector 125, operatively coupled to be in communication with the processor 103 to provide a Housing Position Signal HPS described below.

The processor 103 includes an encoder/decoder 111 with an associated Code Read Only Memory (ROM) 112 storing data for encoding and decoding voice or other signals that may be transmitted or received by the radio telephone 100. The processor 103 also includes a micro-processor 113 coupled, by a common data and address bus 117, to the encoder/decoder 111, a character Read Only Memory (ROM) 114, a Random Access Memory (RAM) 104, a static programmable memory 116 and a SIM module interface 118 for receiving and operatively coupling to a removable SIM (Subscriber Identity Module). The static programmable memory 116 and removable SIM each can store, amongst other things, selected incoming text messages and a Telephone Number Database TND (phonebook) comprising a number field for telephone numbers and name field for identifiers associated with one the numbers in the name field. For instance, one entry in the Telephone Number Database TND may be 91999111111 (entered in the number field) with an associated identifier “Steven C at work” in the name field.

The micro-processor 113 has ports for coupling to the keypad module 106, housing position detector 125, screen 105 and an alert module 115 that typically contains an alert speaker, vibrator motor and associated drivers. Also, micro-processor 113 has ports for coupling to a microphone 135 and communications speaker 140. The character Read only memory 114 stores code for decoding or encoding text messages that may be received by the communication unit 102. In this embodiment the character Read Only Memory 114 also stores operating code (OC) for micro-processor 113 and code for performing functions associated with the radio telephone 100.

The radio frequency communications unit 102 is a combined receiver and transmitter having a common antenna 107. The communications unit 102 has a transceiver 108 coupled to antenna 107 via a radio frequency amplifier 109. The transceiver 108 is also coupled to a combined modulator/demodulator 110 that couples the communications unit 102 to the processor 103.

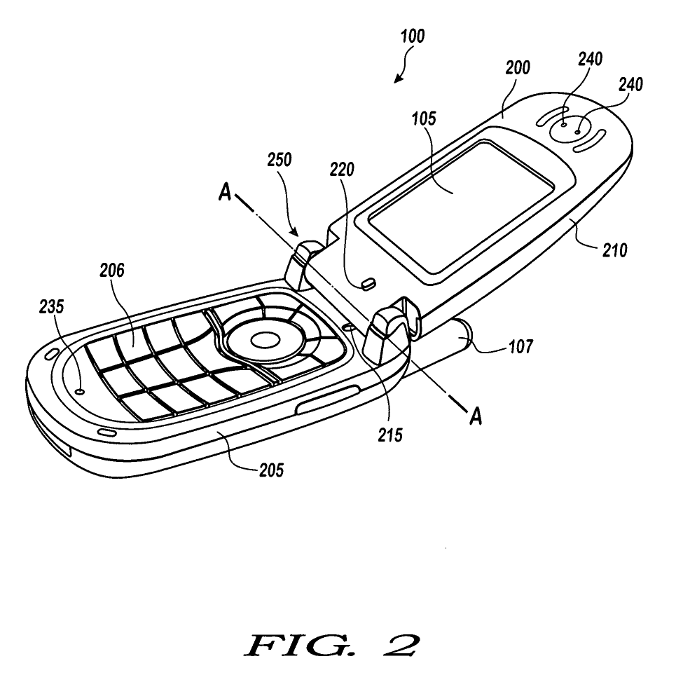

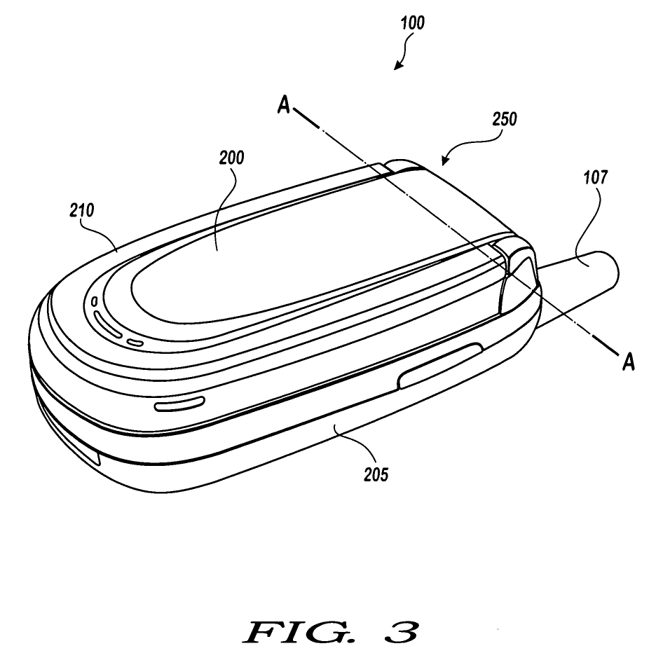

Referring to FIGS. 2 and 3 there is illustrated an embodiment of the closeable (foldable) electronics device in the form of the radio telephone 100 often referred to as a mobile or cellular telephone. The radio telephone 100 has a housing 200 housing with two portions pivotally mounted to each other about a pivotal axis A allowing relative movement thereof between a fully opened position of FIG. 2 and a fully closed position of FIG. 3 and vice versa. The portions are a first portion 205 having a detector aperture 215 therein and a second portion 210 having a protruding detector actuator 220 positioned for operative engagement with the aperture 215 when the portions 205, 210 are in the fully closed position. Housed, or partially disposed, in the housing 200 are the components of FIG. 1 including the transceiver 108, processor 103 and the antenna 107.

In this embodiment, the microphone 135 is mounted in the first portion 205 and is aligned with a communications aperture 235. The speaker 140 is mounted in the second portion 210 and is aligned with communications apertures 240. The keypad module 106 and an associated keypad 206 are mounted (directly or indirectly) to the first portion 205 and the display screen 105 is mounted (directly or indirectly) to portion 210. When the portions 205, 210 are in the closed position the both the keypad 206 and display screen 105 are adjacent each other and are sandwiched between portions 205 and 210. Also, as illustrated two portions 205, 210 are pivotally mounted to each other about the pivotal axis A by a hinge 250.

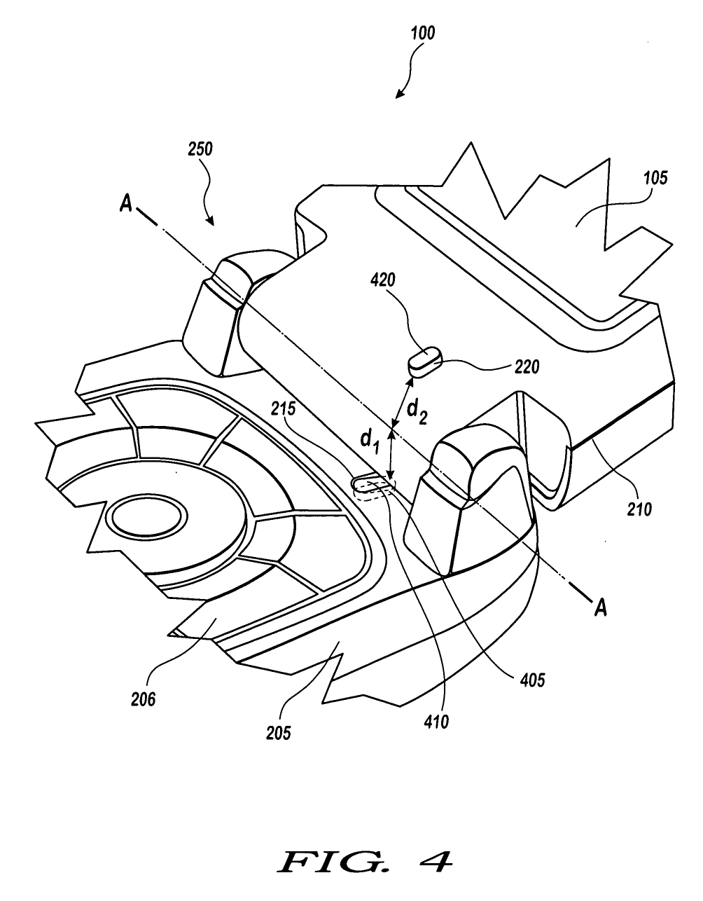

In FIG. 4 there is illustrated a detailed perspective view of the hinge 250 and surrounding area including the detector aperture 215 and protruding detector actuator 220. As shown, the detector aperture 215 is proximal to the hinge 250 in this embodiment it is located at a distance d1 of less than 1 Centimetre from the pivotal axis A. Also, the protruding detector actuator 220 is proximal to the hinge 250 in this embodiment it is located at a distance d2 of less than 1 Centimetre from the pivotal axis A. Looking closely at the detector aperture 215, an angled (tapered) actuator engaging surface 410 of a resilient pad 405 can be seen disposed in the detector aperture 215. Furthermore, the protruding detector actuator 220 has a pad engaging surface 420 so that when the portions 205, 210 are in the closed position the pad engaging surface 420 abuts the actuator engaging surface 410 as described below.

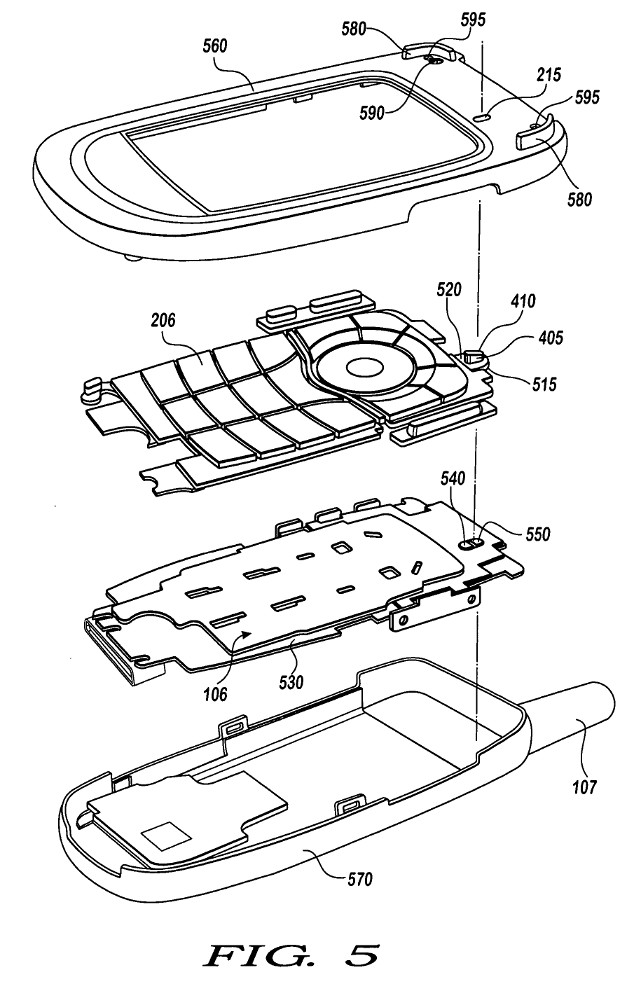

Referring to FIG. 5, there is illustrated an exploded perspective view of the first portion 205 of the closeable electronics device in the form of the radio telephone 100. The resilient pad 405 is formed from a moulded resilient rubber based material (typically silicone rubber) and the resilient pad 405 is integrally moulded into the keypad 206. The resilient pad 405 includes the (angled or tapered) engaging surface 410 located on a free end thereof and there is a conductive shorting member 515 disposed on an underside of the resilient pad 405. The resilient pad 405 also has a flange 520 and below the keypad 206 is a circuit board 530 supporting, amongst others, components of the keypad module 106 that are aligned with respective keys of the keypad 206. There are two spaced switch contacts 540, 550 disposed on the circuit board 530 and typically one of the contacts 540 is directly operatively coupled to the processor 103 by suitable traces on the circuit board 530. Furthermore, the spaced contacts 540, 550 are aligned with: the conductive shorting member 515; and the engaging surface 410; and the detector aperture 215.

A significant number of the components of FIG. 1 are mounted to the circuit board 530 and the keypad 206, including the resilient pad 405 is supported by or on the circuit board 530. More specifically, the resilient pad 405 is supported on the circuit board 530 by the flange 520 and the circuit board 530 and keypad 206 are mounted (disposed) in first portion 205 that comprises a lower part 570 and upper part 560. Furthermore, the upper part 560 has hinge mounting lugs 580 with associated adjacent screw receiving apertures 595. The lugs 580 provide for a positioning guide to assist in mounting outer members of the hinge 250 to the first portion 205 by the screw receiving apertures 595 accommodating securing screws. There is also wiring access aperture 590 disposed in the upper part 560 adjacent one of the lugs 580. This wiring access aperture 590 allows for electrically conductive wires (not shown) to be routed from the first portion 205 to the second portion 210, through the hinge 250, as will be apparent to a person skilled in the art. These wires provide operative coupling of the display screen 105 and speaker 140, mounted in the second portion 210, to the microprocessor 113 that is mounted on the circuit board 530 that is disposed in the first portion 205.

Referring to FIG. 6, there is illustrated a schematic cross sectional view of part of the closeable radio communications in the form of the radio telephone 100 when in a partially opened position. The conductive shorting member 515 that is disposed on the resilient pad 405 has a switch contacting surface 610 aligned with and facing the switch contacts 540, 550. The conductive shorting member 515 is biased away from the switch contacts 540, 550 by resilient properties of the pad 405. These resilient properties are specifically provided by the properties of the resilient rubber based material and a concave or tapered underside 620 (circuit board 530 facing side) of the flange 520, the function of which will be apparent to a person skilled in the art.

As illustrated, a plane PA of the actuator engaging surface 410 is at an angle φ to a plane PS of the switch contacting surface 610 and the plane PA of the actuator engaging surface 410 is both parallel to and facing the pivotal axis A. The angle φ is suitably selected to be between 10 to 20 degrees and the actual angle φ selected depends on the distance of the aperture 215 and protruding detector actuator 220 from the pivotal axis A. In use, the first portion 205 and second portion 210 move relative to each other about the pivotal axis A as indicated by arrows B. Hence, when moving from the opened position to the closed position the protruding detector actuator 220 has a leading corner or leading edge 620 and a trailing corner or trailing edge 630. Since the a plane PA is at the angle φ to a plane PS, the leading edge 620 and trailing edge 630 engage with the actuator engaging surface 410 in a substantially concurrent abutment.

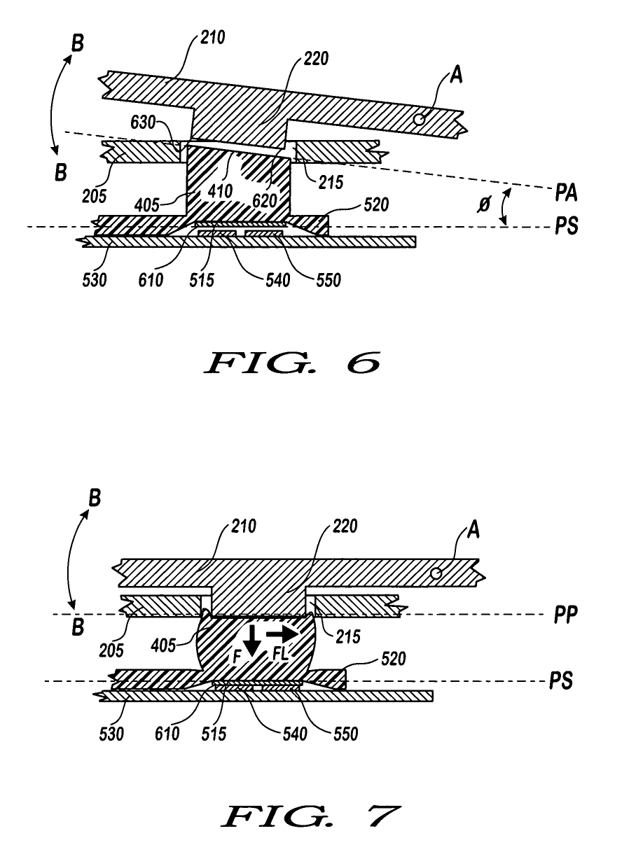

Referring to FIG. 7, there is illustrated a schematic cross sectional view of part of the closeable radio communications in the form of the radio telephone 100 when in a fully closed position. When the portions 205, 210 move between the opened position to the closed position about axis A as illustrated by arrows B, the protruding detector actuator 220 operatively engages the resilient pad 405. More specifically, the pad engaging surface 420 of the protruding detector actuator 220 operatively engages the actuator engaging surface 410 to provide a force F overcoming biasing of the resilient properties of the resilient pad 405 and moves (forces) the conductive shorting member 515 against the switch contacts 540, 550. Also, the angle φ of plane PA of the actuator engaging surface 410 relative to the plane PS of the switch contacting surface 610 is such that the force F has a direction substantially normal to the plane PS of the switch contacting surface. This occurs since the leading edge 620 and trailing edge 630 engage with the actuator engaging surface 410 in a substantially concurrent abutment. Accordingly, lateral forces FL on resilient pad 405 are minimised or alleviated, such lateral forces FL could otherwise result if the leading edge 620 and trailing edge 630 engage with the actuator engaging surface 410 in a non-concurrent abutment.

When in the fully closed position, the conductive shorting member 515 bridges and shorts of the switch contacts 540, 550 and the pad engaging surface 420 has a plane PP substantially parallel to the plane PS of the switch contacting surface. Thus, when the conductive shorting member 515 bridges and shorts of the switch contacts 540, 550 the Housing Position Signal HPS is sent to the processor 103. As a result, and as will be apparent to a person skilled in the art, the Housing Position Signal HPS is typically indicative of two states. These states are the first portion 205 and second portion 210 being: (a) fully closed state; or (b) opened state (fully or partially). These states can be used to determine when inactivating of the display screen 105 is required (e.g. when in the closed state) and when activating of the display screen 105 is required (e.g. when in the opened state). Also, when the telephone 100 is communicating with another telephone (e.g. in a telephone call), termination of the call can be effected by moving portion 205, 210 to the closed position resulting in the Housing Position Signal HPS indicating the fully closed state. Similarly, an incoming call can be answered by the Housing Position Signal HPS indicating the opened state. Other functions controlled by the Housing Position Signal HPS can also be programmed or selected by a user of the telephone 100.

Advantageously, the present invention provides for the leading edge 620 and trailing edge 630 to engage with the actuator engaging surface 410 in a substantially concurrent abutment. This advantageous concurrent abutment is due to the angle φ between plane PA and plane PS. Hence, the present invention reduces or alleviates the problem that can occur due lateral forces FL that could otherwise be applied to resilient pad 405. Such lateral forces may causes unwanted distortion of the resilient pad 405 that may result in reliability issues and incorrect functioning of the detector 125.

The detailed description provides exemplary embodiments only, and is not intended to limit the scope, applicability, or configuration of the invention. Rather, the detailed description of the exemplary embodiments provides those skilled in the art with an enabling description for implementing exemplary embodiments of the invention. It should be understood that various changes may be made in the function and arrangement of elements without departing from the spirit and scope of the invention as set forth in the appended claims. For instance, although a clamshell type device has been illustrated, other closeable devices may be used.

We claim:

1. A closeable electronics device comprising:
a housing having at least two portions pivotally mounted to each other about a pivotal axis allowing relative movement thereof between an opened position and closed position, the portions being a first portion having an detector aperture therein and a second portion having a protruding detector actuator positioned for operative engagement with the aperture when the portions are in the closed position;
a circuit board disposed in the first portion;
two spaced switch contacts disposed on the circuit board,
a resilient pad supported by the circuit board and having an actuator engaging surface disposed in the aperture; and
a conductive shorting member disposed on the pad and having a switch contacting surface aligned with and facing the switch contacts, the conductive shorting member being biased away from the switch contacts by resilient properties of the pad, wherein a plane of the actuator engaging surface is at an angle to a plane of the switch contacting surface, and wherein the plane of the actuator engaging surface is both parallel to and facing the pivotal axis.

2. A closeable electronics device as claimed in claim 1, wherein when in the closed position a pad engaging surface of the protruding detector actuator operatively engages the actuator engaging surface of the pad, and wherein the pad engaging surface has a plane substantially parallel to the plane of the switch contacting surface.

3. A closeable electronics device as claimed in claim 1, wherein when the portions move between an opened position to the closed position the protruding detector actuator operatively engages the pad to provide a force overcoming biasing of the resilient properties and moving the conductive shorting member against the switch contacts, and wherein the angle of plane of the actuator engaging surface relative to the plane of the switch contacting surface is such that the force has a direction substantially normal to the plane of the switch contacting surface.

4. A closeable electronics device as claimed in claim 1, wherein the angle of plane of the actuator engaging surface relative to the plane of the switch contacting surface is between 10 to 20 degrees.

5. A closeable electronics device as claimed in claim 1, wherein two portions is pivotally mounted to each other about the pivotal axis by a hinge.

6. A closeable electronics device as claimed in claim 5, wherein the detector aperture is proximal to the hinge.

7. A closeable electronics device as claimed in claim 6, wherein the detector aperture is located less than 1 Centimetre from the pivotal axis A of the hinge.

8. A closeable electronics device as claimed in claim 1, wherein the pad is formed from a moulded resilient rubber based material.

9. A closeable electronics device as claimed in claim 8, wherein, the pad is integrally moulded into a keypad of the device.

10. A closeable electronics device as claimed in claim 1, wherein one of the switch contacts is operatively coupled to a processor of the device.
